(19) United States
(12) Patent Application Publication
(10) Pub. No.: US 2005/0160638 A1
(43) Pub. Date: Jul. 28, 2005

(54) Greeting card melter and greeting card

(76) Inventor: Thomas E. Donnelly, Bedford, NH (US)

Correspondence Address: MESMER & DELEAULT, PLLC, 41 BROOK STREET, MANCHESTER, NH, 03104, US

(21) Appl. No.: 10/766,070

(22) Filed: Jan. 28, 2004

(51) Int. Cl. G09F 1/00

(52) U.S. Cl. 40/124.06; 40/124.11; 283/117

(57) ABSTRACT

A greeting card melter has a panel enclosure consisting essentially of a shaped recess and a flange, a closure panel releasably secured against the mold panel, and a molded wax body having only a wax formulation disposed in a cavity of defined by the shaped recess and the closure panel. The molded wax body substantially conforms to the shape of the cavity. The greeting card melter optionally includes a greeting card having a leaf configured to hold the greeting card melter.

### BACKGROUND OF THE INVENTION

1. Field of the Invention

The present invention relates generally to wax tarts. Particularly the present invention relates to a wax tart-type component packaged and formed to display a message, a design or both. More particularly, the present invention relates to a wax tart-type component displaying a message, a design or both, and a greeting card.

2. Description of the Prior Art

The use of wax for candles has been around for several centuries. However, it was not until the Middle Ages when beeswax was introduced. More recently, the 18^{th} century whaling industry brought the first major change in candle making. Spermaceti, a wax obtained by crystallizing sperm whale oil, became available in quantity.

It was during the 19^{th} century when most major developments affecting contemporary candle making occurred when a machine was invented to allow continuous production. Further developments occurred around 1850 with the production of paraffin wax made from oil and coal shales. With the introduction of the light bulb in 1879, candle making declined until the turn of the century when a renewed popularity for candles emerged. With the increase of crude oil and meat production, also came an increase in the by-products that are the basic ingredients of contemporary candles; paraffin and stearic acid.

Today, candles symbolize celebration, mark romance, define ceremony, and accent décor. Candles are available in a variety of sizes, colors and scents. Some candles are made with several scents while others are packaged in glass jars, glasses, tin cups, etc. Also available are wax tarts, which have no wick. Wax tarts are made in the shape of a fruit tart, hence, the term “wax tart.” Wax tarts are molded, removed from the mold and wrapped in a clear plastic wrap to allow a customer to visually see the shape and color of the wax tart. A label is applied to the clear plastic wrap indicating the scent of the wax tart. Typically, a wax tart is placed in a wax burner, which is a potpourri type of holder with a location for a votive candle. The votive candle is used to heat and melt the wax tart causing the wax tart scent to be dispersed into the air.

The use of greeting or occasion cards to transmit a sentiment has long been recognized. Greeting cards are available for virtually any holiday or special occasion from an ever-increasing number of annual holidays to a wide variety of special days for a particular individual or to cards which may be sent for no particular occasion. Typically, such a card bears a chosen phrase reflective of the sentiment sought to be transmitted. Greeting cards range from simple, inexpensive printed cards, to more elaborate and expensive cards. Greeting cards also include novelty cards, which play music, light up, or contain moving mechanisms. While receiving a card of any kind is a positive experience, receiving an elaborate or novelty card is an unusual or even extraordinary event in the lives of most people. By way of example, several novelty cards known in the art are disclosed.

U.S. Pat. No. 4,200,222 (1980, Feuer) discloses a greeting card with removable decal. The removable decal is secured to one side by adhesive. A foldable side with an opening having the general outline of the decal, but of smaller perimeter, allows viewing of the decal when the card is folded closed and also assists in maintaining the decal in viewable register with the opening in the card.

U.S. Pat. No. 4,152,865 (1979, Ikeda) discloses a greeting card with holding toy. The holding toy is preferably in the form of an animal having limbs, which are spring-loaded in order to secure the holding toy in place upon the card. The card has decorative indicia on the surface thereof providing a setting for the holding toy. The card is also formed with a cut out portion to receive the holding toy within the outline of the card surface adjacent the decorative indicia.

U.S. Pat. No. 4,787,160 (1988, Balsamo) discloses a greeting card confetti delivery system. The card includes a rupturing adhesive on the inside of a leaf opposite a confetti packet attached to a different leaf. A removable protective coating or covering prevents the confetti packet from contacting the rupturing adhesive when the untriggered card is opened. Removal of the covering triggers the card so that when it is opened thereafter the confetti packet ruptures.

U.S. Pat. No. 3,077,981 (1960, Gaspard) discloses a greeting card in the form of a cylinder made of a suitable material having nonflammable or flame resistant properties and being transparent or translucent in nature. The cylinder transmits light from a source such as a candle, contained therein and which, in turn, is contained within a second cylindrical container manufactured from similar material and capable of sliding up and down within the second cylinder to facilitate the lighting of the candle. The outer container is characterized by colored designs appropriate to the greeting involved so that, when the candle is burning, the designs become illuminated by the candle flame burning within the inner candle container.

U.S. Pat. No. 4,035,937 (1977, Rosenfeld) discloses a candle with integral cardholder. The candle has on the periphery thereof circumferentially spaced, vertical ribs respectively provided therein with circumferentially spaced, vertical, opposed grooves which face each other circumferentially and which are adapted to receive vertical edges of a card, or similar article.

A device known as a candle card has also been available. The company Sourire at www.sourire-nyc.com sells a product known as the Kwanzaa Candle Card that is illustrative of such candle cards. The candle card has an unattached layer of 100% bees. wax folded over the card itself. The unattached bees wax layer is ready to be rolled by the recipient into a hand-made candle.

As evidenced from the previous discussion, a considerable amount of thought has gone into expanding the already wide variety of greeting cards available. Yet, there are unfulfilled areas of expansion that other types of gifts typify. Accordingly, there exists in the greeting card art a need for a new greeting card concept.

Therefore, what is needed is a greeting card concept that provides a wax-based gift b aring a chosen sentiment. What is further needed is a greeting card concept that provides a wax-based gift, which is not a candle, bearing a chosen sentiment and a greeting card combination.

### SUMMARY OF THE INVENTION

It is an object of the present invention to provide a greeting card concept having a wax component packaged into disposable mold and which displays a message, a design, or both that can be used as a greeting card. It is another object of the present invention to provide a greeting card concept having a wax component that can be used as a melter/wax “tart” for potpourri-type wax burners. It is a further object of the present invention to provide a greeting card concept having a wax component that can be used as a melter/wax “tart” for potpourri-type wax burners in combination with a greeting card.

The present invention achieves these and other objectives by providing a greeting card melter having a panel enclosure consisting essentially of a shaped recess and a flange, a closure panel releasably secured against the mold panel, and a molded wax body having only a wax formulation disposed in a cavity defined by the shaped recess and the closure panel. The molded wax body substantially conforms to the shape of the cavity. The flange optionally includes a hanging opening that permits hanging of the greeting card melter in a retail display environment. The wax formulation used to make the wax body contains a predefined fragrance. Although the panel enclosure may be solid, it is preferably transparent or translucent. The shaped recess also preferably contains a message, a design, or both integrally formed within the shaped recess.

In another embodiment of the present invention, the greeting card melter is combined with a greeting card. The greeting card typically has a leaf of the card configured to receive and secure the greeting card melter. The leaf may include a sleeve or pocket for receiving and holding the greeting card melter. The sleeve or pocket may, optionally and preferably, include a window so that the greeting card melter is visible. The window is especially useful in portraying any design or message contained by the wax body and/or panel enclosure.

In yet another embodiment of the present invention, there is disclosed a greeting card system. The greeting card system includes a selection of various greeting card melters, each greeting card melter having a message, a design or both specific for a particular occasion, and a selection of greeting cards configured for use in combination with one of the greeting card melters to form a novelty greeting card. Both the greeting card melters and the greeting cards are displayed in a retail environment to allow the consumer to mix and match greeting card melters and greeting cards.

### BRIEF DESCRIPTION OF THE DRAWINGS

FIG. 1 is a perspective view of the present invention showing the greeting card melter.

FIG. 2 is a cross-sectional view of the present invention shown in FIG. 1.

FIG. 3 is a cross-sectional view of the components of the greeting card melter invention.

FIG. 4 is a perspective view of one embodiment of a combination greeting card melter and a greeting card.

FIG. 5 is a perspective view of another embodiment of a combination greeting card melter and a greeting card.

FIG. 6 is a perspective view of another embodiment of a combination greeting card melter and a greeting card.

### DETAILED DESCRIPTION OF THE PREFERRED EMBODIMENT

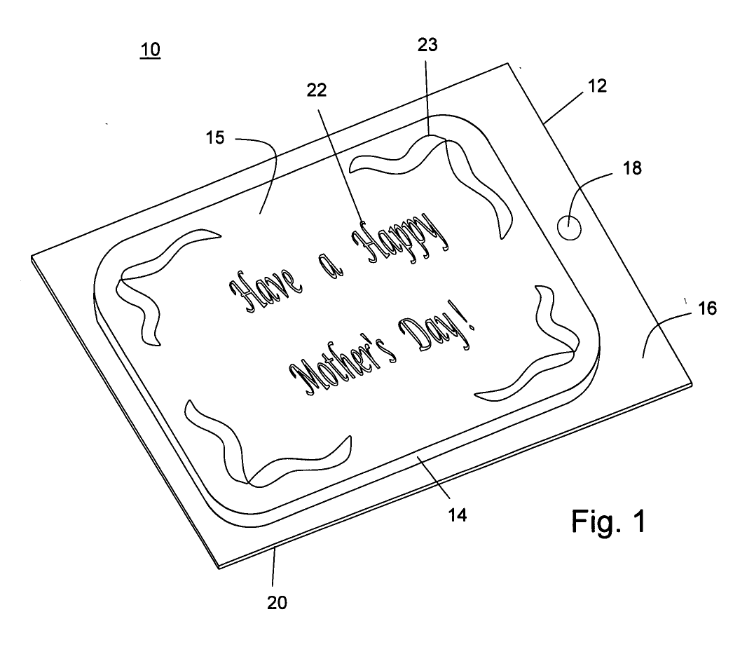

The preferred embodiment(s) of the present invention is illustrated in FIGS. 1-6. FIG. 1 illustrates a greeting card melter 10 having a panel enclosure 12 consisting essentially of a shaped recess 14 and a flange 16. Panel enclosure 12 is preferably made of a plastic material that may be transparent, translucent or solid, but may be made of any other material such as, for example, metal, wood, paper, cardboard, etc. Flange 16 may optionally include a flange opening 18 to permit hanging in a retail display environment. Shaped recess 14 contains a wax body (not shown). Shaped recess 14 has a sentiment 22 displayed on a recess surface 15 that is appropriate for the occasion. Recess surface 15 may also include various symbols 23. Sentiment 22 may be a label (transparent, opaque or solid) attached to surface 15, imprinted directly on to surface 15, or preferably formed into recess surface 15. A closure panel 20 is releasably secured against panel enclosure 12 to hold the wax body within recess 14.

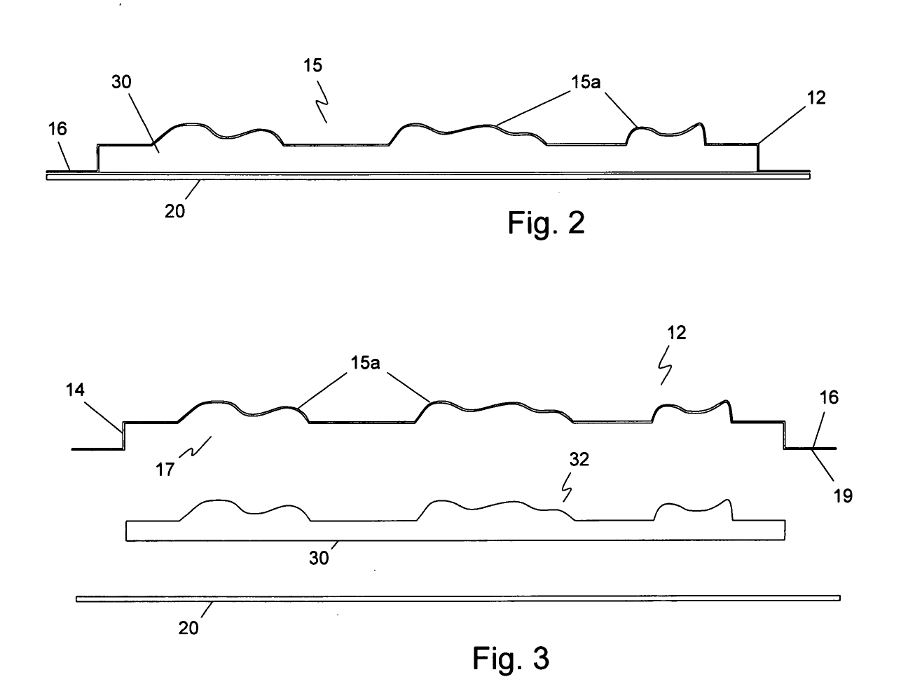

Turning now to FIG. 2, there is shown a cross-sectional view of the present invention. Panel enclosure 12 includes the sentiment 22 formed into recess surface 15 and is represented by a series of raised surface portions 15a that form the desired sentiment 22. Wax body 30 is enclosed within recess 14 and conforms to the shape of recess 14 and recess surface 15. Wax body 30 consists essentially of a wax formulation that typically includes a fragrance. Wax body 30 of the present invention may contain any fragrance or combination of fragrances, including those fragrances used for aroma therapy, and may also include different fragrances that are layered horizontally or vertically. Wax body 30 has a thickness that preferably allows wax body 30 to be broken up by hand into smaller pieces for placement into a wax burner. Wax body 30 is held in recess 14 by closure panel 20.

FIG. 3 shows a side view of greeting card melter 10 where the individual components are separated for clarity. As can be seen from FIG. 3, panel enclosure 12 has shaped recess 14 forming a cavity 17. Flange 16 preferably surrounds the periphery of recess 14 to provide a back surface 19 to which closure panel 20 can be releasably secured. Wax body 30 has a front wax body surface 32 that conforms to the shape of recess 14 including any raised surface portions 15a.

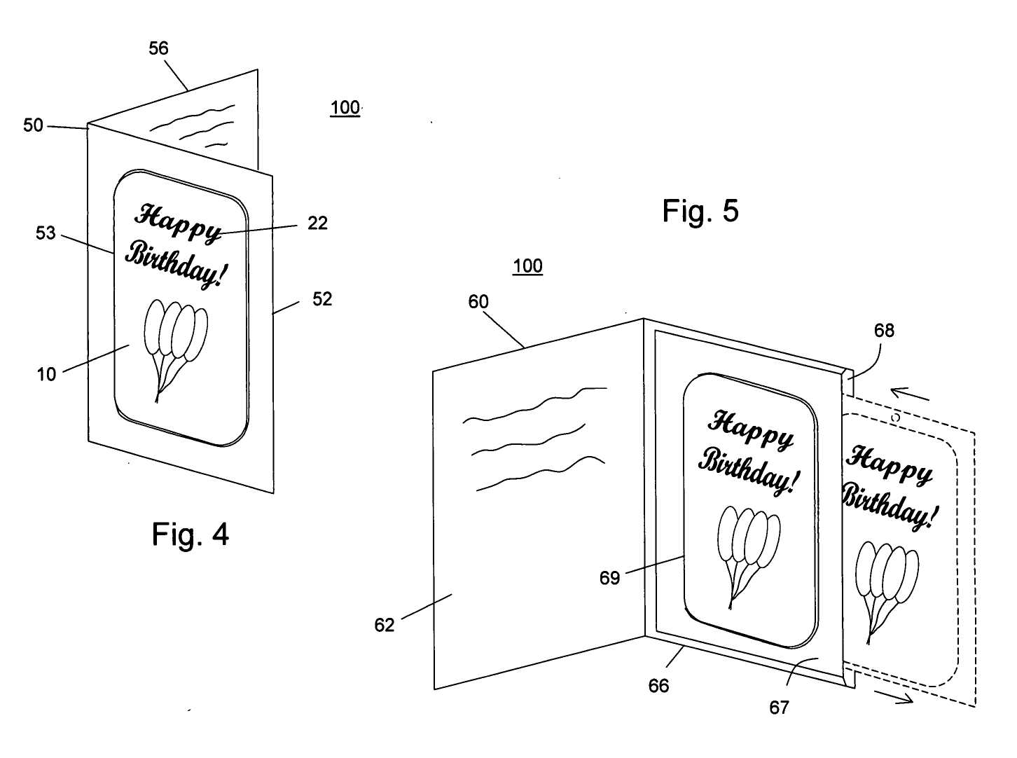

FIG. 4 illustrates one embodiment of a greeting card and greeting card melter combination 100. This embodiment includes a greeting card melter 10 and a greeting card 50. Greeting card 50 is a bi-fold card having a front leaf 52 and a back leaf 56. Front leaf 52 has a window portion 53 in which is mounted greeting card melter 10. In this example, greeting card melter 10 has sentiment 22 providing the expressed sentiment typically provided by conventional greeting cards. Back leaf 56 typically includes conventional phraseology found in greeting cards.

FIG. 5 illustrates another embodiment of greeting card combination 100. This embodiment is also a bi-fold card more typical of conventional greeting cards except for placement of the greeting card melter 10. Like the embodiment in FIG. 4, this embodiment includes a greeting card 60 having a front leaf 62 and a back leaf 66. Front leaf 62 includes the conventional messages and symbols of predefined greeting cards. Back leaf 66 includes a sleeve portion 68 configured for receiving and holding greeting card melter 10 in place. Inside surface 67 of back leaf 66 has a predetermined message displayed along with any optional designs or it may optionally include a window 69 in inside surface 67 through which the greeting card melter 10 is displayed. Greeting card melter 10 is illustrated in phantom lines to indicate one method of inserting and withdrawing greeting card melter 10 into and from sleeve portion 68.

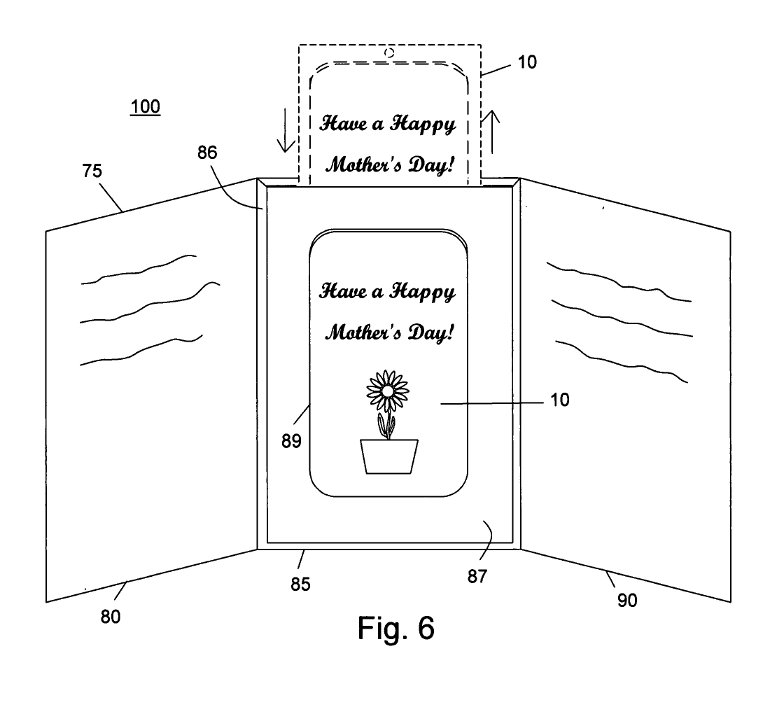

Turning now to FIG. 6, there is illustrated yet another embodiment of greeting card combination 100. This embodiment of greeting card combination 100 includes a tri-fold greeting card 75 having a first leaf 80, a second leaf 85 and a third leaf 90 and greeting card melter 10. Tri-fold greeting card 75 may be a Z-fold or accordion fold, or it may be a two panel fold over that is achieved by folding third leaf 90 over onto second leaf 85 followed by folding first leaf 80 over and onto third leaf 90. In the illustrated embodiment, front leaf 80 includes the conventional messages and symbols of predefined greeting cards. Third leaf 90 also typically includes conventional phraseology found in greeting cards. Second leaf 85 includes a sleeve portion 86 configured for receiving and holding greeting card melter 10 in place. Inside surface 87 of second leaf 85 has a predetermined message displayed along with any optional designs or it may optionally include a window 89 in inside surface 87 through which the greeting card melter 10 is displayed. Greeting card melter 10 is illustrated in phantom lines to indicate one method of inserting and withdrawing greeting card melter 10 into and from sleeve portion 86. It should be understood that any one of the three leafs 80, 85 and 90, respectively, may be configured to receive greeting card melter 10 and any configuration of greeting card and greeting card melter and method of configuring the greeting card to removably receive the greeting card melter are within the scope of the present invention.

The preferred method of making greeting card melter 10 includes obtaining or molding panel enclosure 12 having a recess 14 and a flange 16. A hot wax formulation is poured into recess 14 and allowed to cool forming wax body 30. Recess 14 imparts its shape including any molded sentiment 22 or design 23 to wax body 30. An advantage of molding wax body 30 directly into recess 14 is that as the wax cools, it shrinks making removal of wax body 30 from recess 14 easy. Once wax body 30 is sufficiently cool, a closure panel 20 is releasably secured to panel enclosure 12 to retain wax body 30 within recess 14.

Greeting card melter 10 may then be incorporated into greeting cards and sold as a single unit. Optionally and preferably, a plurality of greeting card melters 10 and a plurality of specially designed greeting cards 100 configured to receive at least one greeting card melter 10 are displayed in a retail environment forming a greeting card system. The greeting card system allows the consumer to select a combination of greeting card melter and greeting card that the consumer believes best conveys the consumer's sentiments. By using the greeting card system, the consumer is able to give an elaborate or novelty card that includes giving a gift in the form of a greeting card melter that can be used by the recipient of the card. While receiving a card of any kind is a positive experience, receiving the novelty card of the present invention will be perceived as unusual or even extraordinary to most recipients.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

1. A greeting card melter comprising:
a panel enclosure consisting essentially of a shaped recess and a flange;
a closure panel releasably secured against said panel enclosure; and
a molded wax body having only a wax formulation disposed in a cavity defined by said shaped recess and said closure panel and substantially conforming to the shape of said cavity.

2. The greeting card melter of claim 1 wherein said flange has a hanging opening whereby said greeting card melter may be hung in a retail display environment.

3. The greeting card melter of claim 1 wherein said wax formulation contains a fragrance.

4. The greeting card melter of claim 1 wherein said wax formulation contains a fragrance and is colored.

5. The greeting card melter of claim 1 wherein said panel enclosure is made of a plastic material that is transparent, translucent or solid.

6. The greeting card melter of claim 1 wherein said shaped recess contains a message, a design, or both integrally formed within said shaped recess of said panel enclosure.

7. In combination, a wax melter and a greeting card, said combination comprising:
a wax melter having a wax body having only a wax formulation, said wax melter capable of being broken into pieces and used in a wax burner in place of a wax tart; and
a greeting card having a leaf configured to hold said wax melter in removable engagement.

8. The combination of claim 7 wherein said wax melter has a front surface containing a message, a design, or both integrally formed within said wax body.

9. The combination of claim 7 wherein said wax melter further includes a panel enclosure consisting essentially of a shaped recess and a flange and a closure panel releasably secured against said panel enclosure.

10. The combination of claim 9 wherein said flange has a hanging opening whereby said greeting card melter may be hung in a retail display environment.

11. The combination of claim 9 wherein said shaped recess contains a message, a design, or both integrally formed within said shaped recess of said panel enclosure.

12. The combination of claim 11 wherein said panel enclosure is made of a plastic material selected from the group consisting of transparent, translucent and solid.

13. The combination of claim 7 wherein said wax formulation contains a fragrance.

14. A greeting card system comprising:
a plurality of greeting card melters wherein each of said plurality of greeting card melters comprising:
a panel enclosure consisting essentially of a shaped recess and a flange;
a closure panel releasably secured against said panel enclosure; and
a molded wax body having only a wax formulation disposed in a cavity defined by said shaped recess and said closure panel and substantially conforming to the shape of said cavity; and
a plurality of greeting cards wherein each of said plurality of greeting cards has a leaf configured for receiving at least one of said plurality of greeting card melters.

15. The greeting card system of claim 14 further comprising a retail store display for presenting said plurality of greeting card melters and said plurality of greeting cards configured for receiving said greeting card melters.

16. The greeting card system of claim 14 wherein said wax body of each of said plurality of greeting card melters has a front surface containing a message, a design, or both integrally formed within said wax body.

17. The greeting card system of claim 14 wherein said flange of said panel enclosure has a hanging opening whereby said greeting card melter may be hung in a retail display environment.

18. The greeting card system of claim 14 wherein said shaped recess contains a message, a design, or both integrally formed within said shaped recess of said panel enclosure.

19. The greeting card system of claim 14 wherein said panel enclosure is made of a plastic material that is transparent, translucent or solid.

20. The greeting card system of claim 14 wherein said wax formulation contains a fragrance.
